(19) United States
(12) Patent Application Publication
(10) Pub. No.: US 2007/0019911 A1
(43) Pub. Date: Jan. 25, 2007

(54) Electrode forming method for a polymer optical waveguide

(76) Inventors: Yuyuing Wu, Chiba (JP); Shigeta Ishikawa, Tokyo (JP)

Correspondence Address: CARLSON, GASKEY & OLDS, P.C., 400 WEST MAPLE ROAD, SUITE 350, BIRMINGHAM, MI, 48009, US

(21) Appl. No.: 11/480,027

(22) Filed: Jun. 30, 2006

(30) Foreign Application Priority Data
Jul. 1, 2005 (JP) 2005-194234

(51) Int. Cl. G02B 6/26

(52) U.S. Cl. 385/40

(57) ABSTRACT

A risk of occurrence of folds, cracks, peeling, and the like in a heater electrode pattern is avoided beforehand by forming a thin-film heater electrode pattern on a polymer optical waveguide with good adhesiveness, and minimizing surface damage of the polymer optical waveguide due to an electrode forming process. According to an electrode forming method for a polymer optical waveguide, after the surface of the polymer optical waveguide is subjected to activation processing, a heater electrode film is formed on the entire surface thereof. A resist is then applied onto the heater electrode film, to form a resist pattern by photolithographic processing in which a heater electrode is patterned. The resist pattern is etched to form a heater electrode pattern, and then remaining resist on the heater electrode pattern is removed.

### RELATED APPLICATIONS

This application is based upon and claims the benefit of priority from the prior Japanese Patent Application No. 2005-194234, filed on Jul. 1, 2005; the entire contents of which are incorporated herein by reference.

### BACKGROUND OF THE INVENTION

1. Field of the Invention

The present invention relates to an electrode forming method for a polymer optical waveguide including an electrode, applied to, for example, an optical switch, a variable optical attenuator, an optical modulator, and various optical transfer modules widely used in a field of optical communications, optical sensing, and the like.

2. Description of the Related Art

Generally, a thermo-optic coefficient of a polymer optical waveguide is larger than that of a quartz optical waveguide by one digit or more. A manufacturing process of the polymer optical waveguide does not require a plasma chemical vapor deposition (CVD) apparatus or a reactive ion etching (RIE) apparatus as in the quartz optical waveguide, and the processing time is very short.

Due to these features, by using the polymer optical waveguide, an optical device with lower cost and less power consumption as compared to using the quartz optical waveguide can be realized.

However, for example, in the polymer optical waveguide using a thermo-optic effect, it is essential to form a thin film heater electrode on the polymer optical waveguide. In this case, there is a technical difficulty in an electrode forming process resulting from an organic property of a polymer material, and this problem must be solved.

In other words, a conventional polymer film has low glass transition temperature Tg, poor heat resistance, and a large thermal expansion coefficient. Therefore, in forming an electrode, a method in which a conductive paste (including a conductive ink and a conductive paint) is applied to perform photo etching (for example, see Japanese Patent Application Laid-Open No. 2004-266078), and a method in which a conductive metal foil is attached by an adhesive to perform photo etching are used.

On the other hand, a recently developed optical polymer material such as polyimide and fluorinated polyimide has higher glass transition temperature Tg than that of the conventional polymer film, and heat resistance thereof exceeds 300° C. Accordingly, an electrode can be formed on the side of a polymer optical waveguide by using reactive ion etching (for example, see Japanese Patent Application Laid-Open No. 2004-109425).

Recently, further, a low-temperature sputtering apparatus to be used as a film-forming apparatus has been developed, and an apparatus having a sputtering temperature of, for example, 80° C. or below has been put on the market. Therefore, an electrode can be deposited on the polymer optical waveguide directly by sputtering.

Therefore, recently, a lift-off method accompanying photolithographic processing, a wet etching method, and a dry etching method can be used as a method of forming an electrode on a polymer optical waveguide.

For reference, one example of a process for forming an electrode on a quartz optical waveguide is shown in FIGS. 1A to 1D. In the electrode forming process, a quartz optical waveguide 320 is first formed on a silicon (Si) substrate 310 (see FIG. 1A).

A resist is then applied on the quartz optical waveguide 320 to form a resist pattern 345 according to photolithographic processing in which an electrode is patterned (see FIG. 1B).

Then, a film 330 is formed, for example, by sequentially sputtering conductive thin film materials such as chromium (Cr) and gold (Au) on the resist pattern 345 (see FIG. 1C).

Thereafter, the resist is lifted off by using a peeling solvent to form a Cr/Au electrode pattern 335 (see FIG. 1D).

However, an organic polymer optical waveguide has a major difference from an inorganic quartz optical waveguide in chemical resistance and adhesiveness with an electrode forming material. For example, a polymer optical waveguide material has a property such that it absorbs, swells, and transubstantiates an organic solvent used for forming a pattern of the thin film electrode. In the polymer material, larger expansion and contraction occur due to fluctuations in process temperature. Further, the polymer material has a problem of poor adhesiveness with a metal material for forming the electrode.

As a result, the polymer material swells by absorbing the organic solvent used in the electrode forming process, thereby likely causing folds and cracks in the electrode pattern, and peeling of the electrode pattern and peeling of the polymer optical waveguide are likely to occur.

For example, if the electrode forming process applied to a general quartz optical waveguide as shown in FIGS. 1A to 1D is used to form an electrode on the polymer optical waveguide, the surface of the polymer optical waveguide is exposed to the organic solvent for a long time in the photolithographic processing and the lift-off process, thereby damaging the surface or generating folds and cracks in the thin film electrode to deteriorate the adhesiveness of the electrode.

Further, when an optical element is formed by using the thermo-optic effect of the polymer optical waveguide, a thick lead electrode for soldering needs to be formed, in addition to forming the thin-film heater electrode on the polymer optical waveguide.

However, formation of the thick lead electrode is more difficult than formation of the thin-film heater electrode, taking into consideration the characteristics of the polymer optical waveguide material such that heat resistance is lower, the thermal expansion coefficient is larger, and resistance against the organic solvent is weaker than the quartz optical waveguide.

### SUMMARY OF THE INVENTION

The present invention has been achieved in order to solve the above problems. It is one object of the present invention to provide an electrode forming method for a polymer optical waveguide, which can avoid beforehand a risk of occurrence of folds, cracks, peeling, and the like in a heater electrode pattern, by forming a thin-film heater electrode pattern on the polymer optical waveguide with good adhesion, minimizing damage on the surface of the polymer optical waveguide due to the electrode forming process.

It is another object of the present invention to provide an electrode forming method for a polymer optical waveguide, which can avoid beforehand a risk of occurrence of folds, cracks, peeling, and the like in the heater electrode pattern and a lead electrode pattern, by forming a thick-film lead electrode pattern in addition to the thin-film heater electrode pattern on the polymer optical waveguide with good adhesion, minimizing damage on the surface of the polymer optical waveguide due to the electrode forming process.

In order to achieve these objects, according to one aspect of the present invention, there is provided an electrode forming method for a polymer optical waveguide including: a step of forming a heater electrode film substantially on an entire surface of a polymer optical waveguide after the surface thereof is subjected to activation processing; a step of applying a resist on the heater electrode film to form a resist pattern by photolithographic processing in which a heater electrode is patterned; a step of etching the resist pattern to form a heater electrode pattern; and a step of removing remaining resist on the heater electrode pattern.

According to another aspect of the present invention, there is provided the electrode forming method for a polymer optical waveguide, wherein the heater electrode film is deposited in one layer or a plurality of layers, using a conductive thin-film material consisting of metals such as chromium (Cr), nickel (Ni), titanium (Ti), tantalum (Ta), gold (Au), platinum (Pt), and aluminum (Al), and alloys thereof.

According to a still another aspect of the present invention, there is provided the electrode forming method for a polymer optical waveguide, wherein the heater electrode film is deposited in one layer or a plurality of layers according to sputtering or a vacuum deposition method.

According to a still another aspect of the present invention, there is provided the electrode forming method for a polymer optical waveguide, wherein a polymer material for the optical waveguide is selected from epoxy resin, polyimide, fluorinated polyimide, polysilane, photosensitive sol-gel material, acrylic resin, silicon resin, polysiloxane, and the like suitable for forming the optical waveguide.

According to a still another aspect of the present invention, there is provided an electrode forming method for a polymer optical waveguide including: a step of forming a heater electrode film substantially on an entire surface of a polymer optical waveguide after the surface thereof is subjected to activation processing; a step of applying a resist onto the heater electrode film to form a first resist pattern by photolithographic processing in which a lead electrode is patterned; a step of forming a lead electrode film on a region where the heater electrode film having the first resist pattern is to be formed; a step of forming a lead electrode pattern by lifting off the first resist pattern; a step of applying a resist onto a region where the heater electrode film having the lead electrode pattern is to be formed, to form a second resist pattern by photolithographic processing in which the lead electrode pattern and the heater electrode are patterned; a step of etching the second resist pattern to form a heater electrode pattern; and a step of removing a resist remaining on the heater electrode pattern and the lead electrode pattern.

According to a still another aspect of the present invention, there is provided the electrode forming method for a polymer optical waveguide, wherein the heater electrode film is deposited in one layer or a plurality of layers, using a conductive thin-film material consisting of metals such as chromium (Cr), nickel (Ni), titanium (Ti), tantalum (Ta), gold (Au), platinum (Pt), and aluminum (Al), and alloys thereof.

According to a still another aspect of the present invention, there is provided the electrode forming method for a polymer optical waveguide, wherein the heater electrode film is deposited in one layer or a plurality of layers according to sputtering or a vacuum deposition method.

According to a still another aspect of the present invention, there is provided the electrode forming method for a polymer optical waveguide, wherein the lead electrode film is formed in a film thickness of 0.5 μm or more, using a metal having small electrical resistance such as gold (Au), platinum (Pt), and aluminum (Al).

According to a still another aspect of the present invention, there is provided the electrode forming method for a polymer optical waveguide, wherein the lead electrode film is formed in a film thickness of 0.5 μm or more according to an electroless plating, sputtering, or a vacuum deposition method.

According to a still another aspect of the present invention, there is provided the electrode forming method for a polymer optical waveguide, wherein a polymer material for the optical waveguide is selected from epoxy resin, polyimide, fluorinated polyimide, polysilane, photosensitive sol-gel material, acrylic resin, silicon resin, polysiloxane, and the like suitable for forming the optical waveguide.

According to a still another aspect of the present invention, there is provided an electrode forming method for a polymer optical waveguide including: a step of forming a heater electrode film substantially on an entire surface of a polymer optical waveguide after the surface thereof is subjected to activation processing; a step of applying a resist onto the heater electrode film to form a first resist pattern by photolithographic processing in which a lead electrode is patterned; a step of forming a lead electrode pattern by electroplating on the heater electrode film that is not covered with the first resist pattern; a step of removing the first resist pattern; a step of applying a resist onto a region where the heater electrode film having the lead electrode pattern is to be formed, to form a second resist pattern by photolithographic processing in which the lead electrode pattern and the heater electrode are patterned; a step of etching the second resist pattern to form a heater electrode pattern; and a step of removing a resist remaining on the heater electrode pattern and the lead electrode pattern.

According to a still another aspect of the present invention, there is provided the electrode forming method for a polymer optical waveguide, wherein the heater electrode film is deposited in one layer or a plurality of layers, using a conductive thin-film material consisting of metals such as chromium (Cr), nickel (Ni), titanium (Ti), tantalum (Ta), gold (Au), platinum (Pt), and aluminum (Al), and alloys thereof.

According to a still another aspect of the present invention, there is provided the electrode forming method for a polymer optical waveguide, wherein the heater electrode film is deposited in one layer or a plurality of layers according to sputtering or a vacuum deposition method.

According to a still another aspect of the present invention, there is provided the electrode forming method for a polymer optical waveguide, wherein the lead electrode film is formed in a film thickness of 0.5 μm or more, using a metal having small electrical resistance such as gold (Au), platinum (Pt), and aluminum (Al).

According to a still another aspect of the present invention, there is provided the electrode forming method for a polymer optical waveguide, wherein a polymer material for the optical waveguide is selected from epoxy resin, polyimide, fluorinated polyimide, polysilane, photosensitive sol-gel material, acrylic resin, silicon resin, polysiloxane, and the like suitable for forming the optical waveguide.

These and other features of the present invention can be best understood from the following specification and drawings, the following of which is a brief description.

### BRIEF DESCRIPTION OF THE DRAWINGS

FIG. 1A is a schematic cross section of a process A in an example of an electrode forming process in a conventional quartz optical waveguide;

FIG. 1B is a schematic cross section of a process B in the example of an electrode forming process in the conventional quartz optical waveguide;

FIG. 1C is a schematic cross section of a process C in the example of an electrode forming process in the conventional quartz optical waveguide;

FIG. 1D is a schematic cross section of a process D in the example of an electrode forming process in the conventional quartz optical waveguide;

FIG. 2A is a schematic cross section of a process A of an electrode forming method for a polymer optical waveguide according to a first embodiment of the present invention;

FIG. 2B is a schematic cross section of a process B of the electrode forming method for a polymer optical waveguide according to the first embodiment of the present invention;

FIG. 2C is a schematic cross section of a process C of the electrode forming method for a polymer optical waveguide according to the first embodiment of the present invention;

FIG. 2D is a schematic cross section of a process D of the electrode forming method for a polymer optical waveguide according to the first embodiment of the present invention;

FIG. 2E is a schematic cross section of a process E of the electrode forming method for a polymer optical waveguide according to the first embodiment of the present invention;

FIG. 2F is a schematic cross section of a process F of the electrode forming method for a polymer optical waveguide according to the first embodiment of the present invention;

FIG. 3A is a schematic cross section of a process A of an electrode forming method for a polymer optical waveguide according to a second embodiment of the present invention;

FIG. 3B is a schematic cross section of a process B of the electrode forming method for a polymer optical waveguide according to the second embodiment of the present invention;

FIG. 3C is a schematic cross section of a process C of the electrode forming method for a polymer optical waveguide according to the second embodiment of the present invention;

FIG. 3D is a schematic cross section of a process D of the electrode forming method for a polymer optical waveguide according to the second embodiment of the present invention;

FIG. 3E is a schematic cross section of a process E of the electrode forming method for a polymer optical waveguide according to the second embodiment of the present invention;

FIG. 3F is a schematic cross section of a process F of the electrode forming method for a polymer optical waveguide according to the second embodiment of the present invention;

FIG. 3G is a schematic cross section of a process G of the electrode forming method for a polymer optical waveguide according to the second embodiment of the present invention;

FIG. 3H is a schematic cross section of a process H of the electrode forming method for a polymer optical waveguide according to the second embodiment of the present invention;

FIG. 3I is a schematic cross section of a process I of the electrode forming method for a polymer optical waveguide according to the second embodiment of the present invention;

FIG. 3J is a schematic cross section of a process J of the electrode forming method for a polymer optical waveguide according to the second embodiment of the present invention;

FIG. 4A is a schematic cross section of a process A of an electrode forming method for a polymer optical waveguide according to a third embodiment of the present invention;

FIG. 4B is a schematic cross section of a process B of the electrode forming method for a polymer optical waveguide according to the third embodiment of the present invention;

FIG. 4C is a schematic cross section of a process C of the electrode forming method for a polymer optical waveguide according to the third embodiment of the present invention;

FIG. 4D is a schematic cross section of a process D of the electrode forming method for a polymer optical waveguide according to the third embodiment of the present invention;

FIG. 4E is a schematic cross section of a process E of the electrode forming method for a polymer optical waveguide according to the third embodiment of the present invention;

FIG. 4F is a schematic cross section of a process F of the electrode forming method for a polymer optical waveguide according to the third embodiment of the present invention;

FIG. 4G is a schematic cross section of a process G of the electrode forming method for a polymer optical waveguide according to the third embodiment of the present invention;

FIG. 4H is a schematic cross section of a process H of the electrode forming method for a polymer optical waveguide according to the third embodiment of the present invention;

FIG. 4I is a schematic cross section of a process I of the electrode forming method for a polymer optical waveguide according to the third embodiment of the present invention;

FIG. 4J is a schematic cross section of a process J of the electrode forming method for a polymer optical waveguide according to the third embodiment of the present invention.

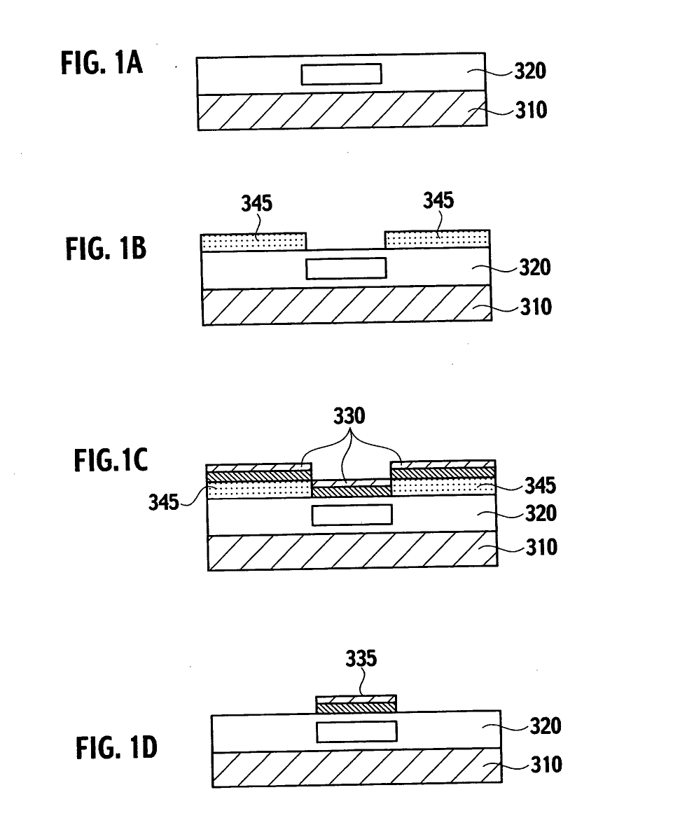

### DETAILED DESCRIPTION OF THE PREFERRED EMBODIMENT

Embodiments of the present invention will be explained with reference to the accompanying drawings.

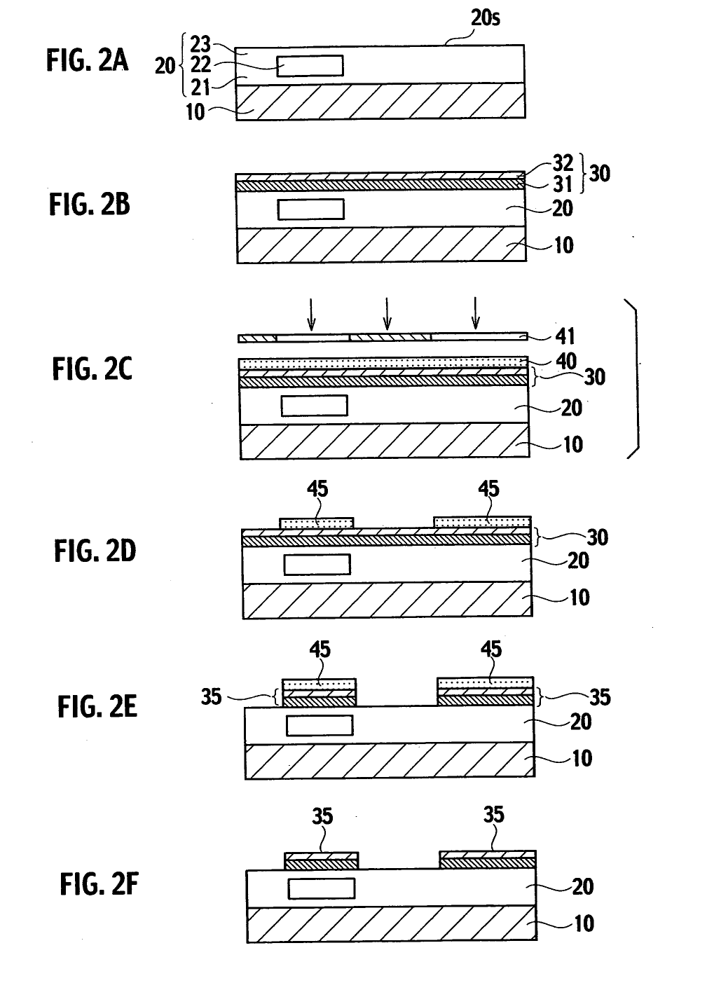

FIGS. 2A to 2F show processes A to F of an electrode forming method for a polymer optical waveguide according to a first embodiment of the present invention, for forming a heater electrode pattern on the polymer optical waveguide.

In the electrode forming process, the surface of a polymer optical waveguide 20 formed on a silicon (Si) substrate 10 is first subjected to an activation process (see FIG. 2A).

For the activation process of the surface of the polymer optical waveguide, ultraviolet plasma processing, plasma processing using an inert gas such as argon (Ar), ultraviolet irradiation processing, or the like is used. In addition to this, the polymer optical waveguide surface can be cleaned and refined by reverse sputtering using the argon (Ar) gas as pretreatment of sputtering.

For example, after a surface 20s of the polymer optical waveguide 20 is subjected to the ultraviolet irradiation processing, reverse sputtering is performed using the argon gas as the pretreatment of sputtering. As a result, the surface of the polymer optical waveguide is cleaned and refined, thereby achieving a surface state with high adhesiveness.

The polymer optical waveguide 20 is formed by sequentially forming a lower cladding layer 21, a core 22, and an upper cladding layer 23 on the silicon (Si) substrate 10.

A heater electrode film 30 is then formed substantially on an entire surface of the polymer optical waveguide 20 (see FIG. 2B).

Specifically, the heater electrode film 30 is formed by performing low temperature sputtering of a conductive thin film material on the entire surface 20s of the polymer optical waveguide 20 with an increased adhesiveness by activation processing.

As the conductive thin film material, metals such as chromium (Cr), nickel (Ni), titanium (Ti), tantalum (Ta), gold (Au), platinum (Pt), and aluminum (Al), and alloys thereof can be used.

The heater electrode film 30 can be formed by depositing the conductive thin film material in one layer or a plurality of layers.

The heater electrode film 30 can be formed not only by the low temperature sputtering but also by, for example, a vacuum deposition method.

In this embodiment, chromium (Cr) is first sputtered at low temperature onto the entire surface 20s of the polymer optical waveguide 20 with an increased adhesiveness, to deposit a Cr layer 31, and then, gold (Au) is sputtered at low temperature thereon to deposit an Au layer 32. Thus, the heater electrode film 30 is formed by these Cr/Au two layers.

A resist 40 is then applied onto the heater electrode film 30 to form a resist pattern 45 (see FIG. 2D) by photolithographic processing in which the heater electrode is patterned (see FIG. 2C).

Specifically, the resist 40 applied on the heater electrode film 30 is exposed from above by using a photomask 41 in which the heater electrode is patterned, and the exposed resist 40 is developed and baked, to form the resist pattern 45. A heater electrode pattern 35 is then formed by etching the resist pattern 45 (see FIG. 2E).

Specifically, the heater electrode pattern 35 is formed by wet etching the resist pattern 45.

The heater electrode pattern 35 can be formed not only by wet etching but also by dry etching.

The resist 45 remaining on the heater electrode pattern 35 is then removed (see FIG. 2F).

As a result, the heater electrode pattern 35 can be formed at a predetermined position on the polymer optical waveguide 20.

The polymer material for the polymer optical waveguide 20 can be selected from epoxy resin, polyimide, fluorinated polyimide, polysilane, photosensitive sol-gel material, acrylic resin, silicon resin, polysiloxane, and the like suitable for forming the optical waveguide.

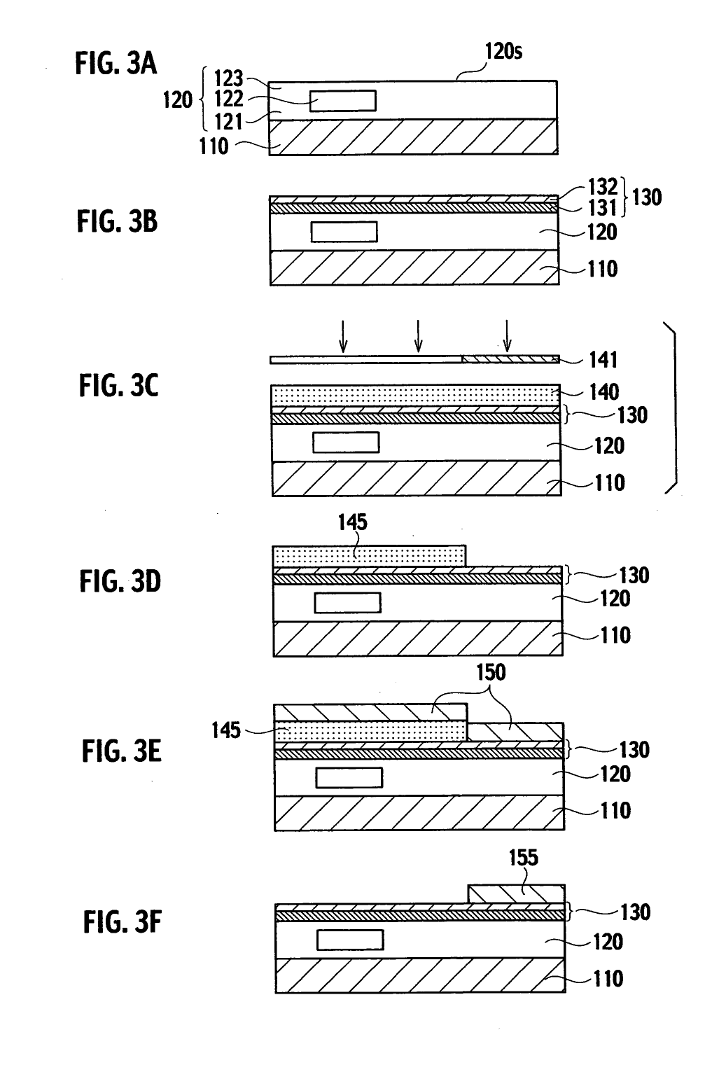

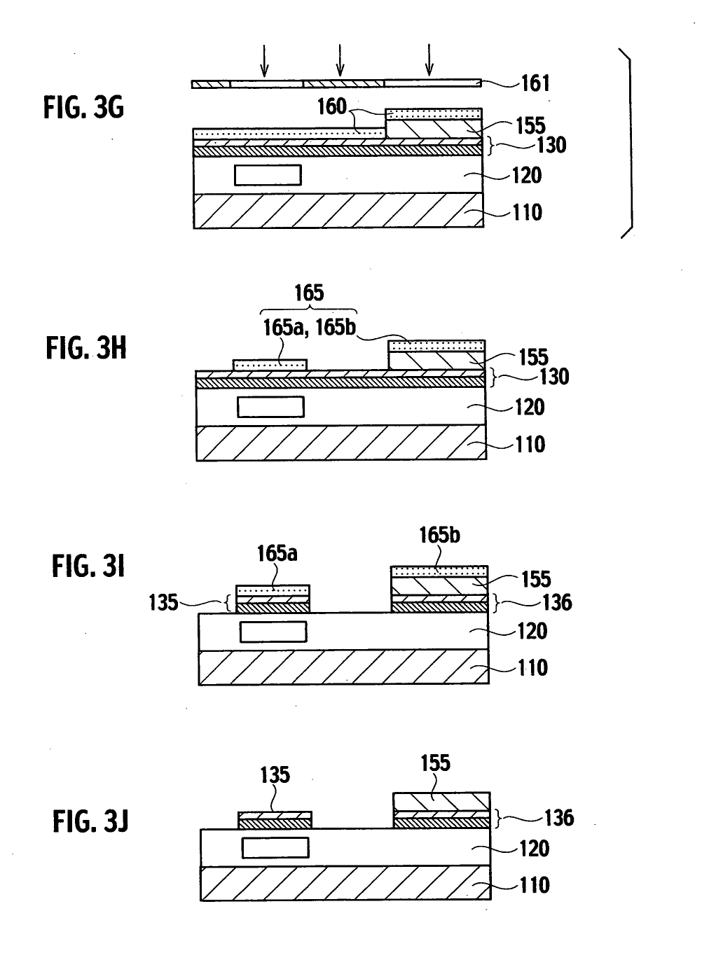

FIGS. 3A to 3J show processes A to J of the electrode forming method for a polymer optical waveguide according to a second embodiment of the present invention, for forming the heater electrode pattern and a lead electrode pattern on the polymer optical waveguide.

In this electrode forming process, the surface of a polymer optical waveguide 120 formed on a silicon (Si) substrate 110 is first subjected to an activation process (see FIG. 3A).

For the activation process of the surface of the polymer optical waveguide, ultraviolet plasma processing, plasma processing using an inert gas such as argon (Ar), ultraviolet irradiation processing, or the like is used. In addition to this, the polymer optical waveguide surface can be cleaned and refined by reverse sputtering using the argon (Ar) gas as pretreatment of sputtering.

For example, after a surface 120s of the polymer optical waveguide 120 is subjected to the ultraviolet irradiation processing, reverse sputtering is performed using the argon gas as the pretreatment of sputtering. As a result, the surface of the polymer optical waveguide is cleaned and refined, thereby achieving a surface state with high adhesiveness.

The polymer optical waveguide 120 is formed by sequentially forming a lower cladding layer 121, a core 122, and an upper cladding layer 123 on the silicon (Si) substrate 110.

A heater electrode film 130 is then formed substantially on an entire surface of the polymer optical waveguide 120 (see FIG. 3B).

Specifically, the heater electrode film 130 is formed by performing low temperature sputtering of a conductive thin film material on the entire surface 120s of the polymer optical waveguide 120 with an increased adhesiveness by activation processing.

As the conductive thin film material, metals such as chromium (Cr), nickel (Ni), titanium (Ti), tantalum (Ta), gold (Au), platinum (Pt), and aluminum (Al), and alloys thereof can be used.

The heater electrode film 130 can be formed by depositing the conductive thin film material in one layer or a plurality of layers.

The heater electrode film 130 can be formed not only by the low temperature sputtering but also by, for example, a vacuum deposition method.

In this embodiment, chromium (Cr) is first sputtered at low temperature onto the entire surface 120s of the polymer optical waveguide 120 with an increased adhesiveness, to deposit a Cr layer 131, and then, gold (Au) is sputtered at low temperature thereon to deposit an Au layer 132. Thus, the heater electrode film 130 is formed by these Cr/Au two layers.

A resist 140 is then applied onto the heater electrode film 130 to form a first resist pattern 145 (see FIG. 3D) by photolithographic processing in which a lead electrode is patterned (see FIG. 3C).

Specifically, the resist 140 applied on the heater electrode film 130 is exposed from above by using a photomask 141 in which the lead electrode is patterned, and the exposed resist 140 is developed and baked, to form the first resist pattern 145.

A lead electrode film 150 is then formed on a region where the heater electrode film 130 having the first resist pattern 145 is to be formed (see FIG. 3E).

Specifically, the lead electrode film 150 is formed by applying electroless deposition of a metal having small electrical resistance on the first resist pattern 145 and on the heater electrode film 130.

For the lead electrode film 150, metals having small electrical resistance such as gold (Au), platinum (Pt), and aluminum (Al) can be used.

It is preferable that the lead electrode film 150 is formed in a film thickness of 0.5 μm or more.

The lead electrode film 150 can be formed not only by the electroless deposition, but also by, for example, sputtering.

Further, the lead electrode film 150 can be formed by vacuum deposition.

A lead electrode pattern 155 is then formed by lifting off the first resist pattern 145 (see FIG. 3F).

Specifically, the lead electrode pattern 155 is formed by removing the lead electrode film 150 on the resist pattern 145, together with the first resist pattern 145, using a lift-off peeling solvent.

A resist 160 is applied onto a region where the heater electrode film 130 having the lead electrode pattern 155 is to be formed, to form a second resist pattern 165 (see FIG. 3H) by photolithographic processing in which the lead electrode pattern 155 and the heater electrode are patterned (see FIG. 3G).

Specifically, the resist 160 applied on the lead electrode pattern 155 and the heater electrode film 130 is exposed from above by using a photomask 161 in which the lead electrode pattern 155 and the heater electrode are patterned, and the exposed resist 160 is developed and baked, to form the second resist pattern 165.

As a result, the second resist pattern 165 includes a resist pattern portion 165a corresponding to the heater electrode pattern and a resist pattern portion 165b corresponding to the lead electrode pattern 155.

A heater electrode pattern 135 is formed by etching the second resist pattern 165 (165a and 165b) (see FIG. 3I).

Specifically, the heater electrode pattern 135 is formed by wet etching the second resist pattern 165 (165a and 165b).

At this time, the heater electrode pattern 135 is formed from the heater electrode film 130, and a lead electrode base pattern 136 is formed below the lead electrode pattern 155.

The heater electrode pattern 135 and the lead electrode base pattern 136 can be formed not only by wet etching but also by dry etching.

The resists 165a and 165b remaining on the heater electrode pattern 135 and the lead electrode pattern 155 are removed (see FIG. 3J).

As a result, the heater electrode pattern 135 and the lead electrode pattern 155 can be formed at predetermined positions on the polymer optical waveguide 120.

The polymer material for the polymer optical waveguide 120 can be selected from epoxy resin, polyimide, fluorinated polyimide, polysilane, photosensitive sol-gel material, acrylic resin, silicon resin, polysiloxane, and the like suitable for forming the optical waveguide.

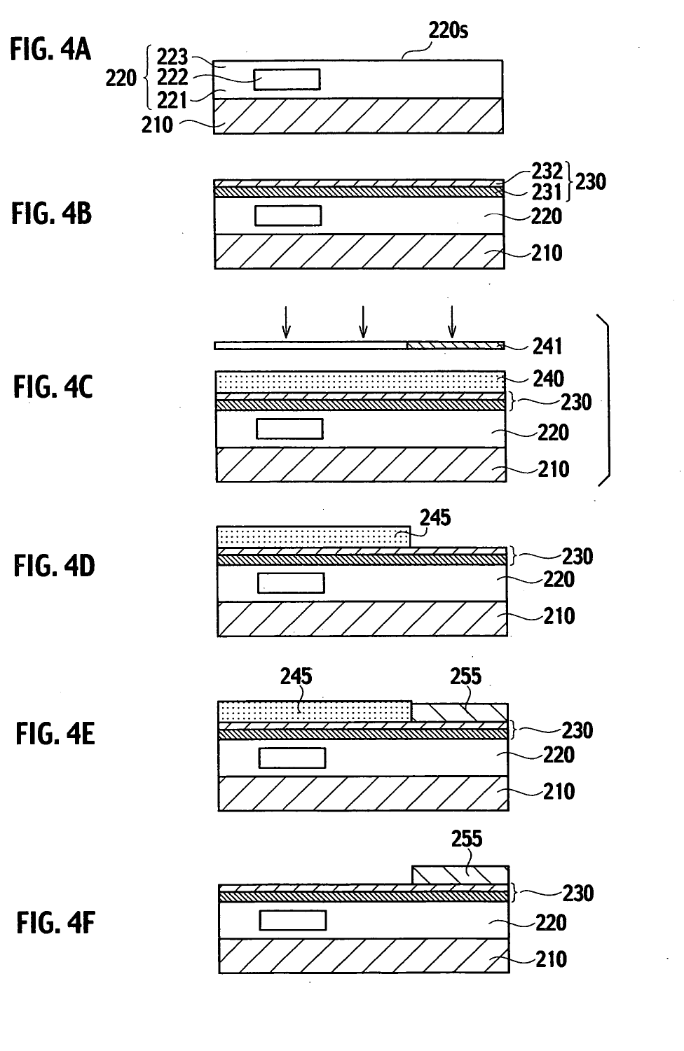

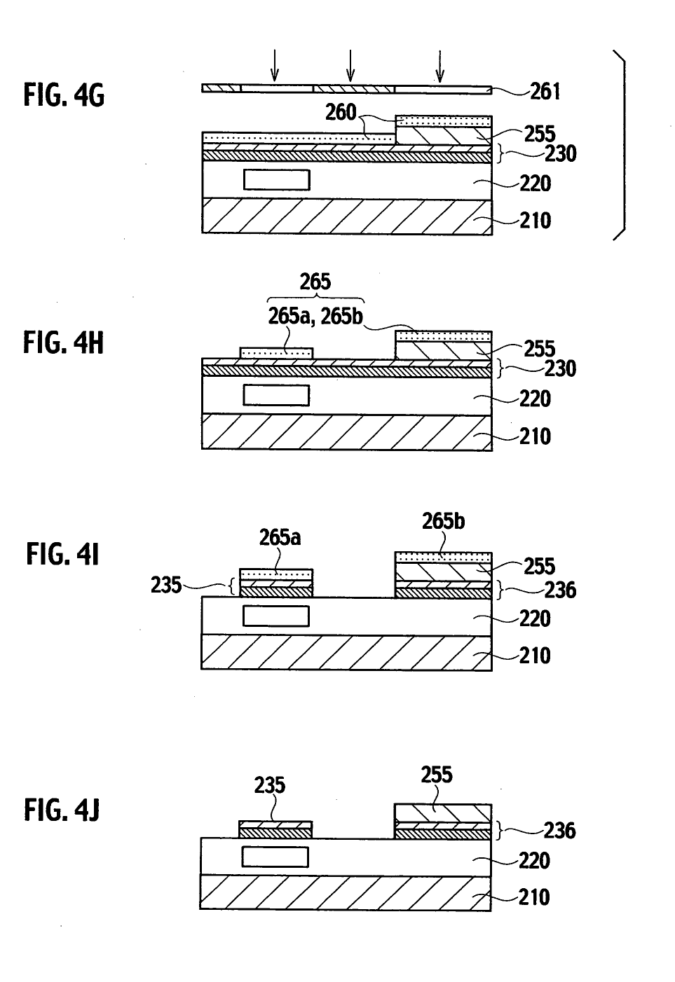

FIGS. 4A to 4J show processes A to J of the electrode forming method for a polymer optical waveguide according to a third embodiment of the present invention. The electrode forming process is different from the process in the second embodiment shown in FIGS. 3A to 3J only in processes E and F, and other processes are identical. Hence, like parts as in the second embodiment are denoted by reference numerals used in FIGS. 3A to 3J added by 100, and only different parts are explained.

The surface of a polymer optical waveguide 220 formed on a silicon (Si) substrate 210 is first subjected to an activation process (see FIG. 4A). A heater electrode film 230 is then formed substantially on an entire surface of the polymer optical waveguide 220 (see FIG. 4B). A resist 240 is then applied onto the heater electrode film 230 to form a first resist pattern 245 (see FIG. 4D) by photolithographic processing in which a lead electrode is patterned (see FIG. 4C). Processes A to D and the contents thereof are the same as those in the second embodiment.

A lead electrode pattern 255 is then formed by electroplating on the heater electrode film 230 that is not covered with the first resist pattern 245, by using conductivity of the heater electrode film 230 (see FIG. 4E).

For the material used for the lead electrode pattern 255, metals having small electrical resistance such as gold (Au), platinum (Pt), and aluminum (Al) can be used.

It is preferable that the lead electrode pattern 255 is formed in a film thickness of 0.5 μm or more.

The first resist pattern 245 is then removed by using a resist peeling solvent (see FIG. 4F).

Thereafter, a resist 260 is applied onto a region where the heater electrode film 230 having the lead electrode pattern 255 is to be formed, to form a second resist pattern 265 (see FIG. 4H) by photolithographic processing in which the lead electrode pattern 255 and the heater electrode are patterned (see FIG. 4G). Then, a heater electrode pattern 235 is formed by etching the second resist pattern 265 (265a and 265b) (see FIG. 4I), and the resists 265a and 265b remaining on the heater electrode pattern 235 and the lead electrode pattern 255 are removed (see FIG. 4J). Processes G to J and the contents thereof are the same as those in the second embodiment.

As a result, the heater electrode pattern 235 and the lead electrode pattern 255 can be formed at predetermined positions on the polymer optical waveguide 220.

As described above, according to the electrode forming method for a polymer optical waveguide of the present invention, low-temperature sputtering of a conductive thin-film material is performed on the entire surface of the polymer optical waveguide with the adhesiveness being increased in advance by activation processing, to form a heater electrode film.

The thus formed electrode film having excellent compatibility covers the surface of the polymer optical waveguide, and hence, in the subsequent photolithographic processing and lift-off process, the surface of the polymer optical waveguide is not exposed directly to the resist solvent, the lift-off peeling solvent, and the like for long time, thereby minimizing damage due to the organic solvent.

As a result, an electrode having good adhesion reliability can be formed without a risk of occurrence of folds, cracks, peeling, and the like in the heater electrode pattern and the lead electrode pattern.

In other words, the risk of occurrence of folds, cracks, peeling, and the like in the heater electrode pattern can be avoided beforehand by forming the thin-film heater electrode pattern on the polymer optical waveguide with good adhesiveness, and minimizing surface damage of the polymer optical waveguide due to the electrode forming process.

According to the electrode forming method for a polymer optical waveguide of the present invention, since the heater electrode film to be formed first on the entire surface of the polymer optical waveguide is a conductive material, by using the conductivity thereof, the plating process of the thick-film lead electrode can be facilitated not only in electroless plating but also in electroplating, thereby simplifying the electrode process.

In other words, the risk of occurrence of folds, cracks, peeling, and the like in the heater electrode pattern and the lead electrode pattern can be avoided beforehand by forming the thick-film lead electrode pattern as well as the thin-film heater electrode pattern on the polymer optical waveguide with good adhesiveness, and minimizing surface damage of the polymer optical waveguide due to the electrode forming process.

In conclusion, according to the electrode forming method for a polymer optical waveguide of the present invention, a thin-film heater electrode and a thick-film lead electrode can be formed without any problem on an optical waveguide made of a polymer material having characteristics of lower heat resistance, larger thermal expansion coefficient, and more vulnerability to organic solvent exposure as compared to a quartz optical waveguide.

For the electrode to be formed on the optical waveguide made of a polymer material, for example, an appropriate combination such as Cr/Au, Cr/Ni/Au, Cr/Ti/Au, and Cr/Al/Ti/Au can be used.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An electrode forming method for a polymer optical waveguide comprising:
a step of forming a heater electrode film substantially on an entire surface of a polymer optical waveguide after the surface thereof is subjected to activation processing;
a step of applying a resist on the heater electrode film to form a resist pattern by photolithographic processing in which a heater electrode is patterned;
a step of etching the resist pattern to form a heater electrode pattern; and
a step of removing a resist remaining on the heater electrode pattern.

2. The electrode forming method for a polymer optical waveguide according to claim 1, wherein the heater electrode film is deposited in one layer or a plurality of layers, using a conductive thin-film material consisting of metals such as chromium (Cr), nickel (Ni), titanium (Ti), tantalum (Ta), gold (Au), platinum (Pt), and aluminum (Al), and alloys thereof.

3. The electrode forming method for a polymer optical waveguide according to claim 1, wherein the heater electrode film is deposited in one layer or a plurality of layers according to sputtering or a vacuum deposition method.

4. The electrode forming method for a polymer optical waveguide according to claim 1, wherein a polymer material for the optical waveguide is selected from epoxy resin, polyimide, fluorinated polyimide, polysilane, photosensitive sol-gel material, acrylic resin, silicon resin, polysiloxane, and the like suitable for forming the optical waveguide.

5. An electrode forming method for a polymer optical waveguide comprising:
a step of forming a heater electrode film substantially on an entire surface of a polymer optical waveguide after the surface thereof is subjected to activation processing;
a step of applying a resist onto the heater electrode film to form a first resist pattern by photolithographic processing in which a lead electrode is patterned;
a step of forming a lead electrode film on a region where the heater electrode film having the first resist pattern is to be formed;
a step of forming a lead electrode pattern by lifting off the first resist pattern;
a step of applying a resist onto a region where the heater electrode film having the lead electrode pattern is to be formed, to form a second resist pattern by photolithographic processing in which the lead electrode pattern and the heater electrode are patterned;
a step of etching the second resist pattern to form a heater electrode pattern; and
a step of removing a resist remaining on the heater electrode pattern and the lead electrode pattern.

6. The electrode forming method for a polymer optical waveguide according to claim 5, wherein the heater electrode film is deposited in one layer or a plurality of layers, using a conductive thin-film material consisting of metals such as chromium (Cr), nickel (Ni), titanium (Ti), tantalum (Ta), gold (Au), platinum (Pt), and aluminum (Al), and alloys thereof.

7. The electrode forming method for a polymer optical waveguide according to claim 5, wherein the heater electrode film is deposited in one layer or a plurality of layers according to sputtering or a vacuum deposition method.

8. The electrode forming method for a polymer optical waveguide according to claim 5, wherein the lead electrode film is formed in a film thickness of 0.5 μm or more, using a metal having small electrical resistance such as gold (Au), platinum (Pt), and aluminum (Al).

9. The electrode forming method for a polymer optical waveguide according to claim 5, wherein the lead electrode film is formed in a film thickness of 0.5 μm or more according to an electroless plating, sputtering, or a vacuum deposition method.

10. The electrode forming method for a polymer optical waveguide according to claim 5, wherein a polymer material for the optical waveguide is selected from epoxy resin, polyimide, fluorinated polyimide, polysilane, photosensitive sol-gel material, acrylic resin, silicon resin, polysiloxane, and the like suitable for forming the optical waveguide.

11. An electrode forming method for a polymer optical waveguide comprising:
a step of forming a heater electrode film substantially on an entire surface of a polymer optical waveguide after the surface thereof is subjected to activation processing;
a step of applying a resist onto the heater electrode film to form a first resist pattern by photolithographic processing in which a lead electrode is patterned;
a step of forming a lead electrode pattern by electroplating on the heater electrode film that is not covered with the first resist pattern;
a step of removing the first resist pattern;
a step of applying a resist onto a region where the heater electrode film having the lead electrode pattern is to be formed, to form a second resist pattern by photolithographic processing in which the lead electrode pattern and the heater electrode are patterned;
a step of etching the second resist pattern to form a heater electrode pattern; and
a step of removing a resist remaining on the heater electrode pattern and the lead electrode pattern.

12. The electrode forming method for a polymer optical waveguide according to claim 11, wherein the heater electrode film is deposited in one layer or a plurality of layers, using a conductive thin-film material consisting of metals such as chromium (Cr), nickel (Ni), titanium (Ti), tantalum (Ta), gold (Au), platinum (Pt), and aluminum (Al), and alloys thereof.

13. The electrode forming method for a polymer optical waveguide according to claim 11, wherein the heater electrode film is deposited in one layer or a plurality of layers according to sputtering or a vacuum deposition method.

14. The electrode forming method for a polymer optical waveguide according to claim 11, wherein the lead electrode film is formed in a film thickness of 0.5 μm or more, using a metal having small electrical resistance such as gold (Au), platinum (Pt), and aluminum (Al).

15. The electrode forming method for a polymer optical waveguide according to claim 11, wherein a polymer material for the optical waveguide is selected from epoxy resin, polyimide, fluorinated polyimide, polysilane, photosensitive sol-gel material, acrylic resin, silicon resin, polysiloxane, and the like suitable for forming the optical waveguide.
